(19) United States
(12) Patent Application Publication
(10) Pub. No.: US 2023/0303249 A1
(43) Pub. Date: Sep. 28, 2023

(54) Aircraft Cargo Loading/Unloading Device

(71) Applicant: Aaron Zhang, Los Angeles, CA (US)

(72) Inventors: Aaron Zhang, Los Angeles, CA (US); Evan Hertafeld, Los Angeles, CA (US)

(21) Appl. No.: 18/056,436

(22) Filed: Nov. 17, 2022

(30) Foreign Application Priority Data
Mar. 23, 2022 (CN) 202210292602.3

(51) Int. Cl. B64D 1/22

(52) U.S. Cl. CPC B64D 1/22

(57) ABSTRACT

A cargo loading/unloading device for an aircraft includes a base, two arms pivotally movable on top of the base and a push rod pivotally connected to the base and sandwiched between the two arms. A cable extends through the push rod and forms into a loop after passing through a bottom end of the push rod so that a package is able to be securely transported with the cooperation of the push rod and the two arms and be released onto the arms when the package weight is not functioning.

### BACKGROUND

### Technical Field

The present invention relates to a cargo loading/unloading device, and in particular to a cargo loading/unloading device for aircrafts.

### Related Art

Small aircraft (known as aircraft) has been widely used in different fields in our daily lives, such as entertainment, surveillance, transportation . . . and so on. Due to its light-weight, environment-friendly and easy maintenance, people are getting used to these kinds of vehicle for different tasks.

When an aircraft is used to transport a package, a parcel, or a cargo, normally, an electric reel is applied to lift and/or lower the package when arriving the designated location. After the package is dropped or being loaded onto the aircraft, the electric reel is then operated to retreat the cable or to secure the package.

In order to secure the package and prevent the package from falling to the ground, an usual practice is to securely tie the package up at the very end of the cable. When arriving at the designated destination, a recipient or a designated personnel is required to untie the cable in order to free the package. However, before the package is removed from the aircraft, a crucial criteria is that the aircraft has be in the air for a sufficient period of time so that the designated personnel has enough time to remove the package from the aircraft. When the designated personnel is not at the site previously agreed on, the package will not be removed from the aircraft in time, which wastes lots of time waiting from the personnel to arrive. Also, this approach restricts the time of the personnel to some extent, which means the designated personnel has to arrive at the agreed location at the agreed time and that inevitably increases cost.

A Chinese patent application 202011450524.2 discloses a package delivery system and the method thereof for aircrafts. The system includes a racket for accommodation of a package, a cable connected to the racket and having a loop formed at a free end thereof for engagement/disengagement with the package such that when the cable is in tension, the loop is securely connected to the package and the racket and when the cable is not in tension, the loop frees the package and the racket. This application adopts a unique racket and a particular way of rounding the cable onto the racket so that when the aircraft is in the air, the gravity of the package applies onto the cable to stretch the cable so that the cable is in tension, which also secures the safety of the package. When the aircraft reaches the destination and lands on the ground, the gravity of the package no longer applies onto the cable and the loop frees the racket and the package. No human interference during the entire unloading process, which greatly reduces delivery efficiency. However, it is found that this kind of system applies only to packages with small weight and little volume. What's more is that there is special requirements for the package handle to connect to the loop. For packages with large weight and volume, this system is not adequate to successfully fulfill the originally designed function as the package cannot be easily freed from the racket.

As a result of current situation, there is a need to modify the already-existing package loading and unloading system for aircrafts.

### SUMMARY

The primary objective of the preferred embodiment of the present invention is to provide a package loading/unloading device for an aircraft, which comprises
a base with a tongue extending out from a side face thereof;
a rod connected to the base and having a cable extending through the push rod and provided with a loop on a outer periphery of the push rod to correspond to releasably surround the tongue; and
at least one arm reciprocally movable on a top face of the base such that a package is able to be securely transported when package weight functions onto the two arms due to interaction between the cable and the package and released when the package weight no longer functions on the two arms.

Another objective of the preferred embodiment of the present invention is that the base further has two stations formed on the top face thereof to respectively accommodate a distal end of a corresponding one of the two arms to allow the two arms to pivot on the top face of the base.

Another objective of the preferred embodiment of the present invention is that the base further has a hinge formed on the top face thereof and sandwiched between the two stations to accommodate a distal end of the push rod to allow the push rod to pivot on the top face of the base.

Another objective of the preferred embodiment of the present invention is that each of the stations has a first rod formed therein to pass into a distal end of a corresponding one of the two arms so that the two arms are able to pivot on the top face of the base.

Another objective of the preferred embodiment of the present invention is that the hinge has a second rod formed therein to pass into the distal end of the push rod to allow the rod to pivot on the top face of the base.

Another objective of the preferred embodiment of the present invention is that the rod further comprises a through hole defined inside the push rod to allow the cable to pass there through such that one end of the cable is adapted to connect to the aircraft and the other end thereof forms into the loop after passing a bottom end of the push rod.

Another objective of the preferred embodiment of the present invention is that the base further comprises two tracks formed on the top face thereof and the two arms respectively have a stop formed on a bottom face thereof to correspond to the tracks so that when the two arms are pivotal movable on the top face of the base, the stops are moved within the tracks.

Another objective of the preferred embodiment of the present invention is that each of the two arms has a L shaped cross section.

### BRIEF DESCRIPTION OF THE DRAWINGS

FIGS. 1-4 are views showing the package loading/unloading device of the first embodiment of the present invention where the unloading device is not in operation, in which, FIG. 1 is a perspective view, FIG. 2 is a top plan view, FIG. 3 is a bottom plan view and FIG. 4 is a side plan view;

FIGS. 5-8 are views showing the package loading/unloading device of the first embodiment of the present invention where the unloading device is in operation, in which, FIG. 5 is a perspective view, FIG. 6 is a top plan view, FIG. 7 is a bottom plan view and FIG. 8 is a side plan view;

FIGS. 9-11 are views showing status of the package loading/unloading device of the first embodiment of the present invention before the package released to the ground, in which, FIG. 9 is a perspective view, FIG. 10 is a top plan view and FIG. 11 is a side plan view;

FIGS. 12-14 are schematic perspective views showing the operational status of the package loading/unloading device of the first embodiment of the present invention after the package is released;

FIGS. 15-17 schematic side plan views showing the operational status of the package loading/unloading device of the first embodiment of the present invention after the package is released;

FIGS. 18-19 are structural schematic views showing the package loading/unloading device of the second embodiment of the present invention where the unloading device is not in operation, in which, FIG. 18 is a perspective view and FIG. 19 is a side plan view;

FIGS. 20-21 are structural schematic views showing the package loading/unloading device of the second embodiment of the present invention, where the unloading device is in operation, in which FIG. 20 is a perspective view and FIG. 21 is a side plan view;

FIGS. 22-23 are views showing the operational status of the package loading/unloading device of the second embodiment of the present invention before the package is released, in which FIG. 22 is a perspective view, and FIG. 23 is a side plan view; and

FIGS. 24-25 are views showing the operational status of the package loading/unloading device of the second embodiment of the present invention after the package is released, in which FIG. 22 is a perspective view, and FIG. 23 is a side plan view.

### DETAILED DESCRIPTION

The present invention will be further described with reference to the accompanying drawings and specific embodiments. It is to be noted that the following embodiment(s) is only for explanation purpose and should not be deemed as a limitation to the scope sought. Particularly, the following embodiment(s) uses a drone to explain what the structure is, how the device is working and what effect it can achieve.

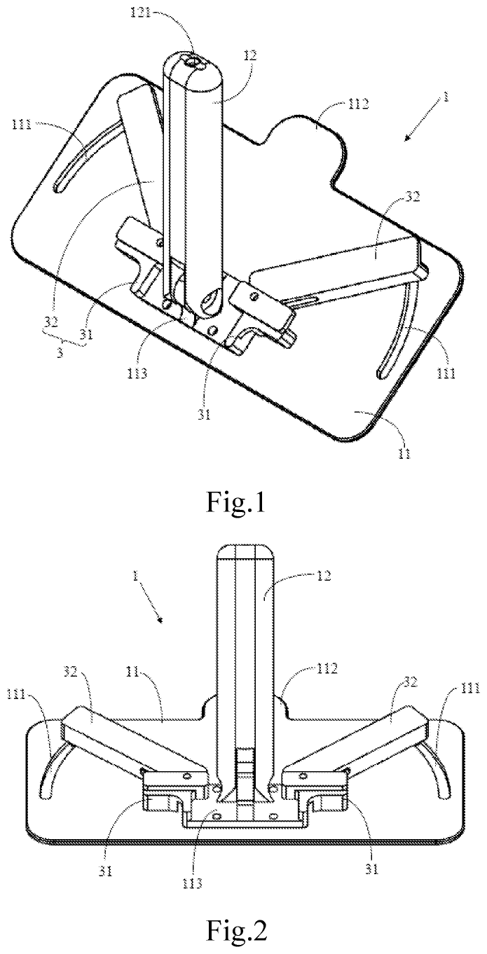

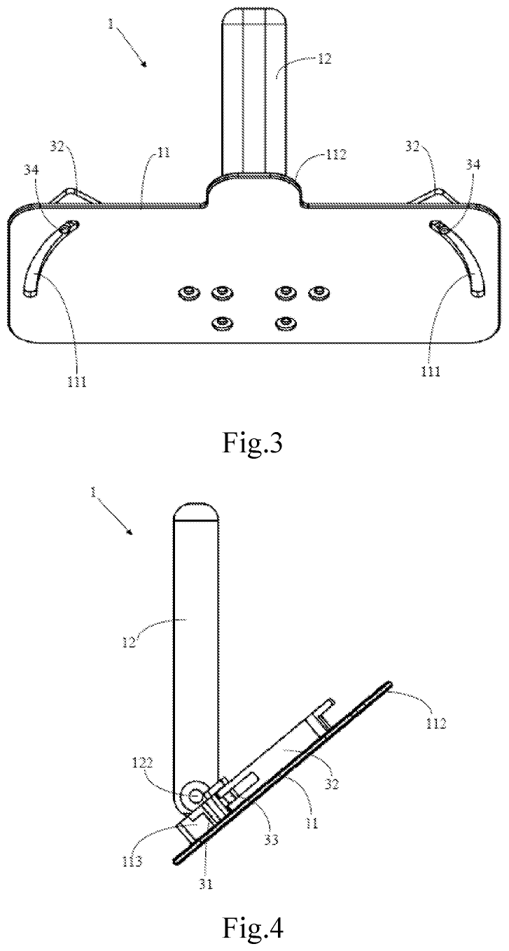

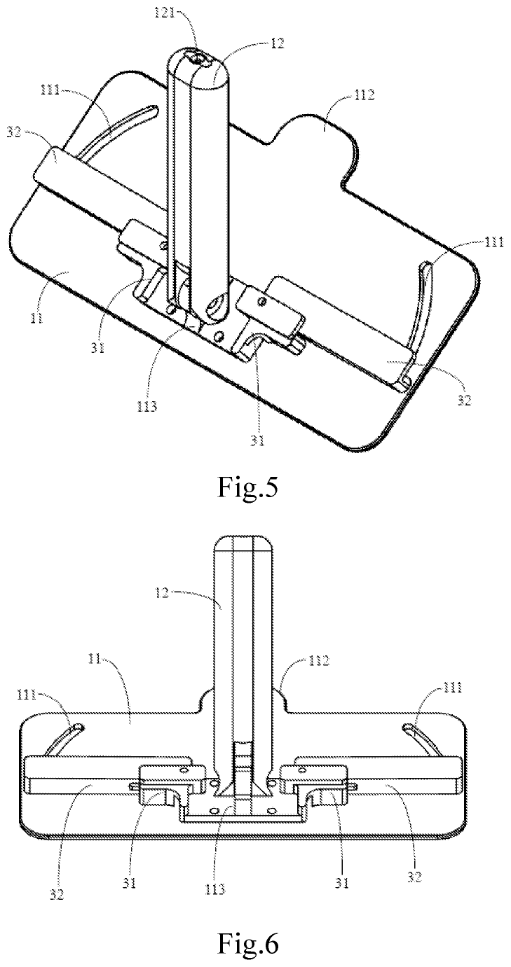

Referring to FIGS. 1-8, the package loading/unloading device for a miniature (aircraft) aircraft is shown and has a rack 1 for a package to be loaded and an unloading device 3 to assist the rack 1 to unload the package so loaded.

Specifically, the package loading/unloading device for an aircraft includes a loading dock 1 and an exit device 3. The exit device 3 includes a pair of stations 31 respectively and securely formed on a side face of a base 11 and having a first rod 33 formed inside of each of the stations 31 and two arms 32 pivotally formed on top of a hinge 113 which is formed on the base 11 and having the first rod 33 passing through a bottom end of each of the arms 32 to allow the two arms 32 to pivot on top of the base 11. It is to be noted that the two arms 32 are respectively spring (not shown) biased so that when the two arms are pivoted, there is energy stored inside the spring and when a force making the two arms 32 to pivot disappear, the previously stored recovery force from the spring retreat the two arms 32 back to their original position respectively.

The loading dock 1 has the plan base 11 provided with two arcuate tracks 111 formed on two sides thereof to correspond to the two arms 32 of the exiting device 3, a tongue 112 extending out from one side thereof and the hinge 113 located between the two stations 31 and having therein a second rod 122 and a push rod 12 pivotally connected to the top face thereof and having the second rod 122 passing into a distal end of the push rod 12 to allow the push rod 12 to pivot relative to the top face of the base 11.

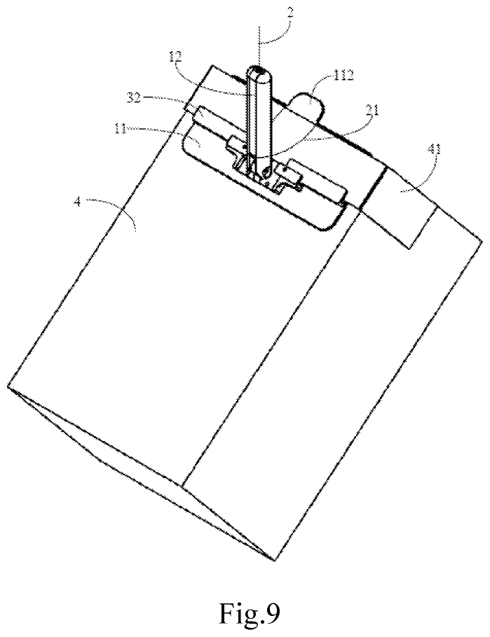

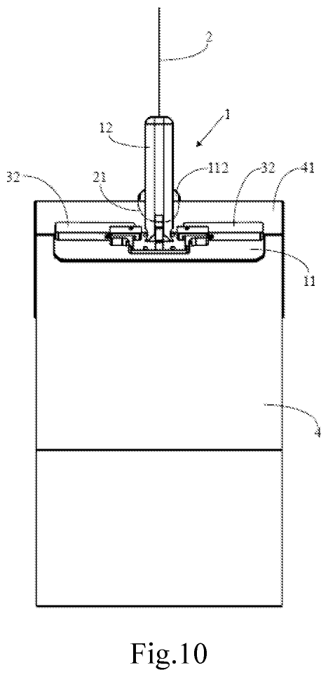

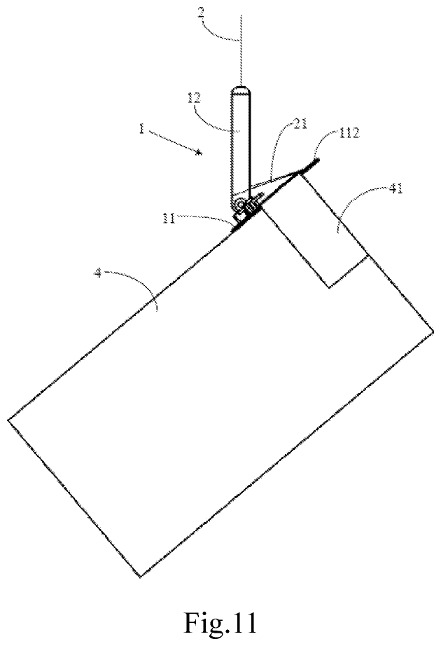

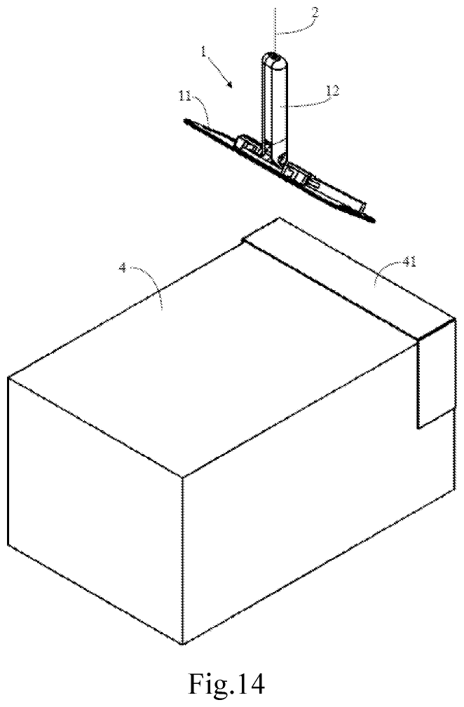

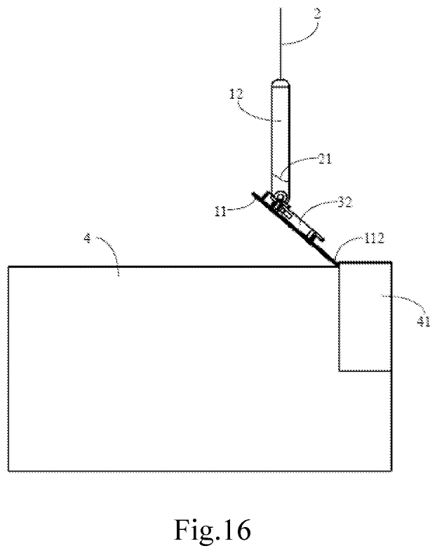

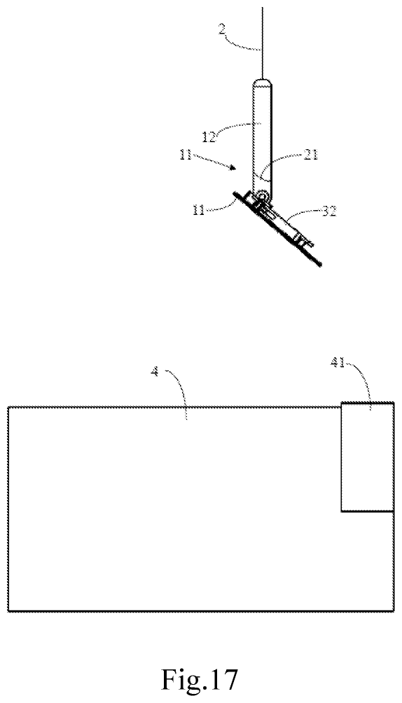

With reference to FIGS. 9-17, when the loading dock 1 is applied to a package, a cable 2 is required and wound around a cable releasing/retrieving assembly, such as a reel on an aircraft, i.e., aircraft. The cable 2 is extended into a through hole 121 defined through the push rod 12 and out from the distal end of the push rod 12 and forms into a loop 21 corresponding to the tongue 112 after passing around an outer periphery of the push rod 12, like what is shown in FIGS. 9-11. That is, when a package 4 is applied to the loading dock 1 and attached to the exit device 3, the weight of the package 4 tightens the cable 2, which enables the loop 21 to securely attach to the tongue 112 of the base 11.

Like previously described, the two arms 32 are spring-biased. However, the spring recovery force is designed to be smaller than the package weight itself, but larger than that of the combination of the loading dock 1 and the exit device 3. As a result, when the loading/unloading device of the embodiment of the present invention is put in application and when the aircraft is in the air, the weight of the package tightens the cable 2 and the two arms 32 are able to securely attach to a side of the package after the two arms 32 are pivotally moved sideways along the tracks 111 respectively.

It is also to be noted that even the two arms 32 are described to be spring-biased, the spring-biased mechanism can be changed to a rubber band to provide the required recovery force, in which one end of which is securely attached to the base 11 and the other end of which is attached to the package. Before the aircraft (or the package) lands on the ground, the package weight itself tightens the rubber band. After the package is landed on the ground, the rubber band automatically gets away from the package and sets the package free from the base 11.

When the cargo loading/unloading device of the preferred embodiment of the present invention is put in application, a package 4 is prepared and placed on top of the base 11 and one side of the package 4 is biased against the push rod 12. The package 4 is normally equipped with a handle for the base 11 of the loading dock 1. In the preferred embodiment of the present invention, the package 4 is equipped with a tape 41 wound around an upper portion of the package 4, still leaving a space between an inner side face of the tape 41 and an outer periphery of the package 4. A thin membrane (not shown) may be applied into the space to avoid the adhesive on the inner side face of the tape to glue to the base 11. When in use, the base 11 is inserted into the space between the tape 41 and the package 4 and the tongue 112 is extended out of the tape 41. In the meantime, the two arms 32 are pivotally moved in a direction away from the tongue 112 as a result of the stop from the tape 41. After which, the loop 21 engages the tongue 112 to allow the cable 2 to tightly wrap around the package 4 between the push rod 12 and the base 11.

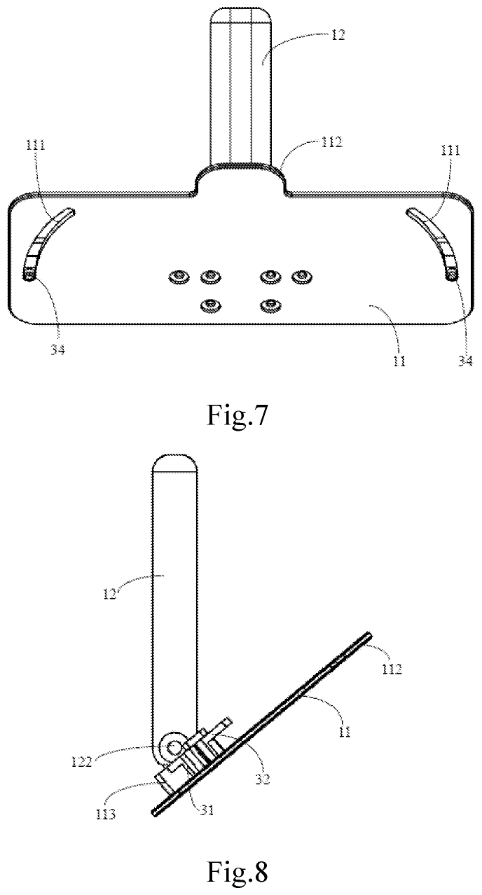

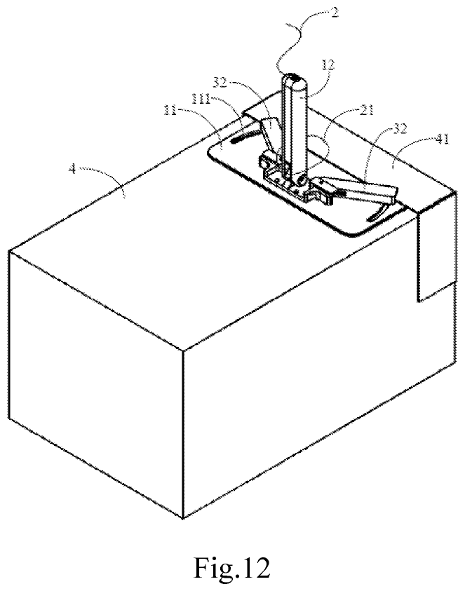

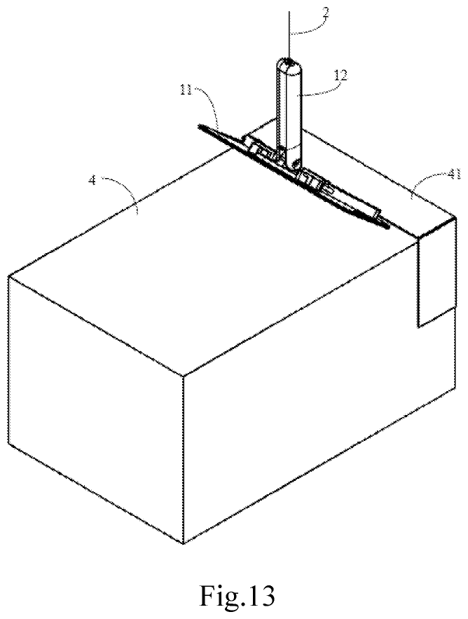

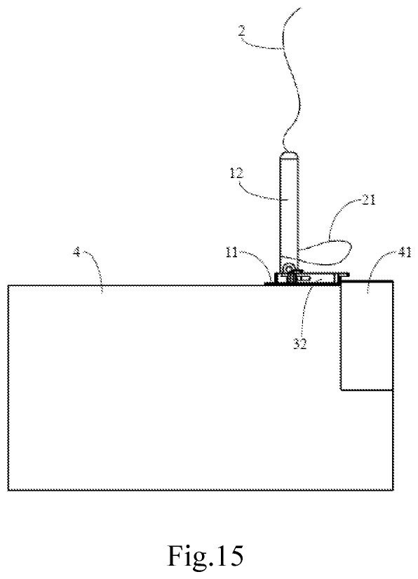

When the aircraft lifts the package 4, the package weight tightens the cable 2 and because the package 4 is now securely positioned by both the base 11 and the two arms 32, the package 4 is, therefore, securely transported. When the aircraft reaches the previously determined destination and lands, as shown in FIGS. 12 and 15, as the package weigh no longer applies to the base 11, the recovery force from the spring biased arms 32 pushes against the tape 41 to move the base 11 away from the package 4. In the meantime, the loop 21 disengages with the tongue 12. In order to prevent the tape 4 from being jammed between the arms 32 and the outer periphery of the package 4 or slipped underneath the arms 32, a stop 34, as shown in FIG. 7 is formed under each of the arms 32 and movably received within a corresponding one of the tracks 111 so that with the provision of the stops 34, when the exit device 3 functions, the two arms 32 are able to successfully push the tape 4 (or handle) to exit the cargo loading/unloading device of the preferred embodiment of the present invention from the package 4. After the package 4 leaves the device of the preferred embodiment, the aircraft lifts, along with the cable 2. It is noted that when the loop 21 is formed, the cable 2 extends into the through hole 121 inside the push rod 12 and comes out of the push rod 12 from a bottom end thereof. After the distal end of the cable 2 passes the outer periphery of the push rod 12, the distal end of the cable 2 forms into the loop 21 on the other periphery of the push rod 12 such that when the aircraft lifts, the loop 21 wrap around the outer periphery of the push rod 12 and the lifting force from the aircraft lifts the entire device successfully, as shown in FIGS. 13-14 and FIGS. 16-17.

### Embodiment 2

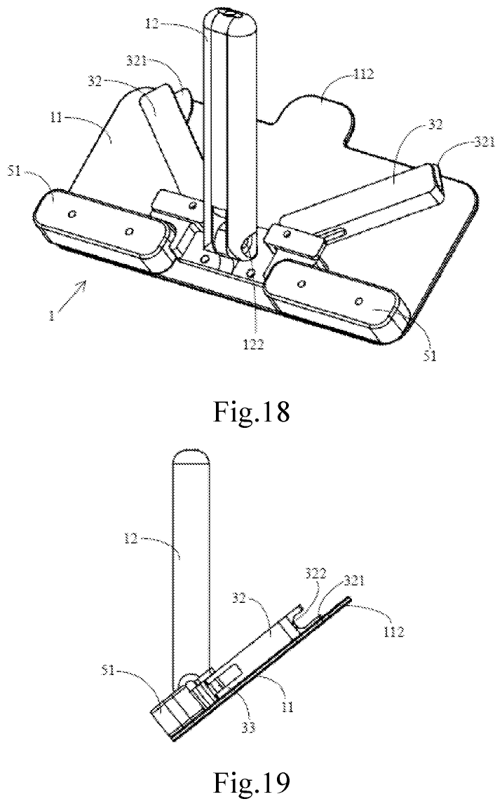

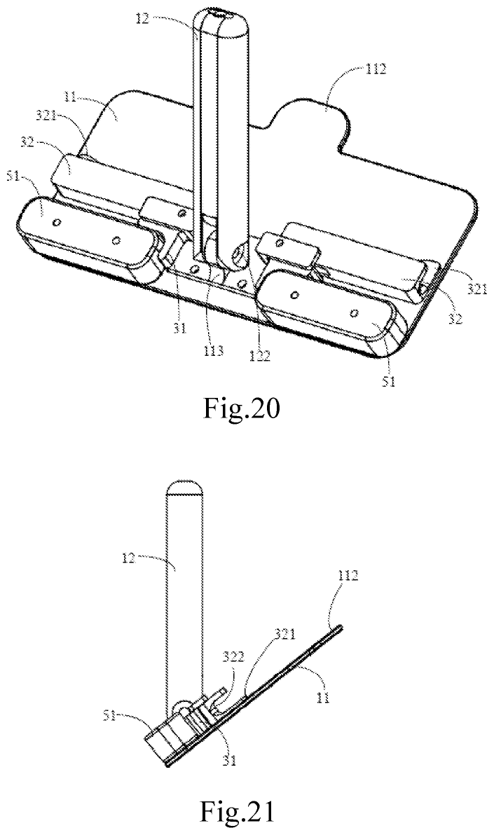

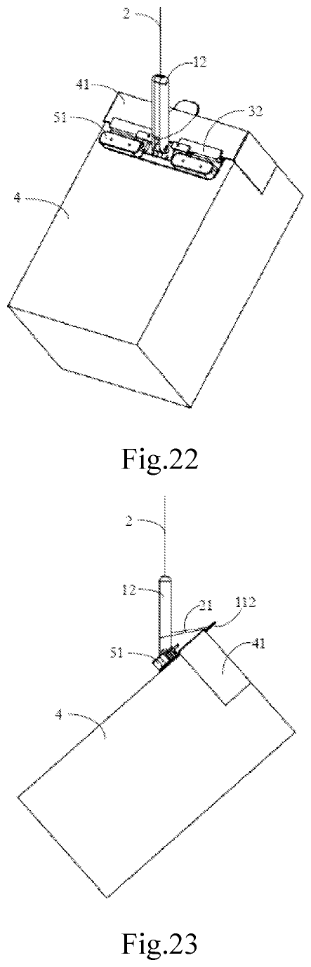

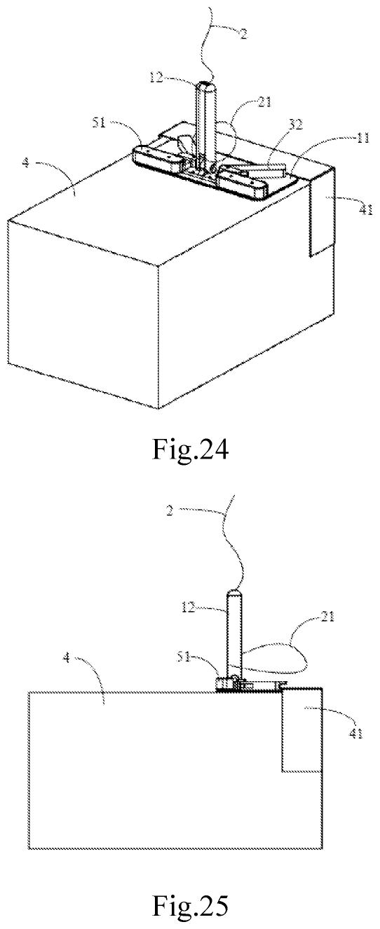

With reference to FIGS. 18-25, a second preferred embodiment of the cargo loading/unloading device for an aircraft is shown. In the first embodiment, a stop 34 is employed to prevent the tape 4 from gluing to the arms 32 and also from slipping underneath the arms 32 to cause the package 4 still attached to the device of the preferred embodiment of the present invention. With the stop 34 moving along the corresponding tracks 111, the tape 4 might just be pushed by the arms 32 successfully. However, the tape 4 may still get caught inside the tracks 111 leading to the result that the package 4 cannot be unloaded from the device of the preferred embodiment of the present invention. In order to prevent such situation from happening, another design is to remove the tracks 111 and the corresponding stops 34 and add in a trough 322 defined in a side face facing the tape 41 and having a width larger than that of the tape 41. Therefore, after the aircraft (or the package 4) is landed, as shown in FIGS. 22-23, the cable 2 is loosed and the spring biased arms 32 pushes the tape 41 with the help of the trough 322, as shown in FIGS. 24-255. The tape 41 is well received inside the trough 322 and the package 4 is then released.

Also, each arm 32 may includes a side plate, a top plate and a bottom plate 321. The top plate and the bottom plate are formed on two opposite sides of the side plate such that the combination of the top plate and the side plate has a L shaped cross-section. The bottom plate 321 engages with the top face of the base 11 and is located away from the stations 31, as shown in FIGS. 18-21. The trough 322 is defined in a joint of the side plate, the top plate and the bottom plate 321, preferably, a joint between the bottom plate 321 and the side plate is arcuate.

The present invention is described above in detail with reference to the embodiments of the accompanying drawings, and a person of ordinary skill in the art may make various modifications to the present invention according to the above description. Therefore, some details in the embodiments shall not constitute a limitation on the present invention, and the protection scope of the present invention shall be subject to the scope of the appended claims.

What is claimed is:

1. A package loading/unloading device for an aircraft comprises:
a base;
a rod connected to the base and having a cable extendable and retrievable through the rod and provided with a loop on a outer periphery of the rod so as to correspond to releasably secure a package; and
at least one arm reciprocally movable on a face of the base such that the package is able to be securely transported when package weight functions onto the cable due to interaction between the cable and the package and released when the package weight no longer functions on the cable.

2. The device as claimed in claim 1, wherein the base further has at least one station formed on the face thereof to respectively accommodate a distal end of the at least one arm to allow the at least one arm to be reciprocal movement on the face of the base.

3. The device as claimed in claim 1, wherein the base further has a hinge formed on the face thereof to accommodate a distal end of the rod to allow the rod to move on the face of the base.

4. The device as claimed in claim 2, wherein the base further has a hinge formed on the face thereof to accommodate a distal end of the rod to allow the rod to move on the face of the base.

5. The device as claimed in claim 2, wherein the at least one station has a first rod formed therein to pass into a distal end of the at least one arm so that the at least one arm is able to move on the face of the base.

6. The device as claimed in claim 3, wherein the at least one station has a first rod formed therein to pass into a distal end of the at least one arm so that the at least one two arm is able to move on the face of the base.

7. The device as claimed in claim 4, wherein the at least one station has a first rod formed therein to pass into a distal end of the at least one arm so that the at least one two arm is able to pivot on the face of the base.

8. The device as claimed in claim 3, wherein the hinge has a second rod formed therein to pass into the distal end of the rod to allow the rod to pivot on the face of the base.

9. The device as claimed in claim 4, wherein the hinge has a second rod formed therein to pass into the distal end of the rod to allow the rod to move on the face of the base.

10. The device as claimed in claim 6, wherein the hinge has a second rod formed therein to pass into the distal end of the rod to allow the rod to move on the face of the base.

11. The device as claimed in claim 1, wherein the rod further comprises a through hole defined inside the rod to allow the cable to pass there through such that one end of the cable is adapted to connect to the aircraft and the other end thereof forms into the loop after passing a bottom end of the rod.

12. The device as claimed in claim 6, wherein the rod further comprises a through hole defined inside the rod to allow the cable to pass there through such that one end of the cable is adapted to connect to the aircraft and the other end thereof forms into the loop after passing a bottom end of the rod.

13. The device as claimed in claim 7, wherein the rod further comprises a through hole defined inside the rod to allow the cable to pass there through such that one end of the cable is adapted to connect to the aircraft and the other end thereof forms into the loop after passing a bottom end of the rod.

14. The device as claimed in claim 8, wherein the rod further comprises a through hole defined inside the rod to allow the cable to pass there through such that one end of the cable is adapted to connect to the aircraft and the other end thereof forms into the loop after passing a bottom end of the rod.

15. The device as claimed in claim 9, wherein the rod further comprises a through hole defined inside the rod to allow the cable to pass there through such that one end of the cable is adapted to connect to the aircraft and the other end thereof forms into the loop after passing a bottom end of the rod.

16. The device as claimed in claim 10, wherein the rod further comprises a through hole defined inside the rod to allow the cable to pass there through such that one end of the cable is adapted to connect to the aircraft and the other end thereof forms into the loop after passing a bottom end of the rod.

17. The device as claimed in claim 1, wherein the base further comprises at least one track formed on the face thereof and the at least one arm has a stop formed on a bottom face thereof to correspond to the at least one track so that when the at least one two arm is reciprocally movable on the face of the base, the stop is moved within the at least one track.

18. The device as claimed in claim 10, wherein the base further comprises at least one track formed on the face thereof and the at least one arm has a stop formed on a bottom face thereof to correspond to the at least one track so that when the at least one two arm is reciprocally movable on the face of the base, the stop is moved within the at least one track.

19. The device as claimed in claim 16, wherein the base further comprises at least one track formed on the face thereof and the at least one arm has a stop formed on a bottom face thereof to correspond to the at least one track so that when the at least one two arm is reciprocally movable on the face of the base, the stop is moved within the at least one track.

20. The device as claimed in claim 19, wherein the at least one arm has an L shaped cross section.
